(19) United States
(12) Patent Application Publication
(10) Pub. No.: US 2014/0302397 A1
(43) Pub. Date: Oct. 9, 2014

(54) Methods for Making Electrodes

(71) Applicant: 3M INNOVATIVE PROPERTIES COMPANY, St. Paul, MN (US)

(72) Inventors: Andrew T. J. van Bommel, London (CA); Ranjith Divigalpitiya, London (CA)

(73) Assignee: 3M INNOVATIVE PROPERTIES COMPANY, St. Paul, MN (US)

(21) Appl. No.: 14/345,690

(22) PCT Filed: Dec. 13, 2012
(86) PCT No.: PCT/US2012/069352

§ 371 Date: Mar. 19, 2014

Related U.S. Application Data
(60) Provisional application No. 61/576,632, filed on Dec. 16, 2011.

(51) Int. Cl. H01M 4/04; H01M 10/0525; H01M 4/1391; H01M 4/13; H01M 4/139

(52) U.S. Cl. CPC H01M 4/0404; H01M 4/13; H01M 4/139; H01M 4/1391; H01M 10/0525
USPC 429/233; 427/58; 427/126.3; 427/122

(57) ABSTRACT

A method of forming an electrode for a lithium-ion battery. The method includes providing a metallic substrate and coating the metallic substrate with a substantially solvent free electroactive coating composition. Coating the metallic substrate includes buffing the electroactive coating composition onto a major surface of the metallic substrate.

### TECHNICAL FIELD

The present disclosure relates to electrodes useful in lithium-ion electrochemical cells, and methods of making the same.

### BACKGROUND

Various methods have been employed to make battery electrodes and/or deposit materials useful in battery electrodes. For example, methods are described in U.S. Pat. No. 5,720,780 (Liu et al.), U.S. Pat. No. 6,589,299 (Missling et al.), U.S. Pat. No. 6,939,383 (Eastin et al.), U.S. Patent Application Publication 2010/0055569 (Divigalpitiya et al.), and JP Pub. No. 2009 252629 (Toshiya et al.).

### SUMMARY

In some embodiments, a method of forming an electrode for a lithium-ion battery is provided. The method includes providing a metallic substrate and coating the metallic substrate with a substantially solvent free electroactive coating composition. Coating the metallic substrate includes buffing the electroactive coating composition onto a major surface of the metallic substrate.

In some embodiments, an electrode for a lithium-ion battery is provided. The electrode is prepared by providing a metallic substrate and coating the metallic substrate with a substantially solvent free electroactive coating composition. Coating the metallic substrate includes buffing the electroactive coating composition onto a major surface of the metallic substrate.

In some embodiments, a lithium-ion battery comprising an electrode is provided. The electrode is prepared by providing a metallic substrate and coating the metallic substrate with a substantially solvent free electroactive coating composition. Coating the metallic substrate includes buffing the electroactive coating composition onto a major surface of the metallic substrate.

The above summary of the present disclosure is not intended to describe each embodiment of the present invention. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIGS. 1A-1B illustrate charge-discharge curves of battery cells prepared in accord with some embodiments of the present disclosure.

FIGS. 2A-2B illustrate a charge-discharge curve and a discharge capacity versus cycle number curve, respectively, of a battery cell prepared in accord with some embodiments of the present disclosure.

FIGS. 3A-3B illustrate a charge-discharge curve and a discharge capacity versus cycle number curve, respectively, of a battery cell prepared in accord with some embodiments of the present disclosure.

FIGS. 4A-4B illustrate a charge-discharge curve and a discharge capacity versus cycle number curve, respectively, of a battery cell having electrodes prepared using solvent-based methods.

### DETAILED DESCRIPTION

Secondary electrochemical cells, such as lithium-ion electrochemical cells are composed of a negative electrode and a positive electrode separated by a porous polymer separator. Lithium ions are transferred between the positive and negative electrode through a lithium-ion-conducting electrolyte.

In a typical electrode for such lithium-ion electrochemical cells, an electroactive composition is coated and/or adhered onto and in electrical contact with a current collector. Current collectors are typically electrically-conductive metallic strips. The electroactive composition is often made up of an active electrode material (the material that intercalates and deintercalates lithium ions), a conductive diluent (to improve electronic conductivity), and a polymeric binder (to improve contact between the positive electrode materials and to the current collector).

In a typical process to fabricate electrodes for a lithium-ion battery, the electroactive composition components are mixed in an organic, volatile solvent to form a slurry. The slurry is then coated onto the current collector using a conventional coating technique (e.g., knife coating, spray coating, or spin coating) and dried in an oven.

Reducing or eliminating solvent from a method of producing battery electrodes has obvious advantages, including environmental advantages in the production of less waste, and elimination of processing steps that are designed to remove the solvent after deposition of the electrode materials onto a current collector, with elimination of associated costs, time, and labor. Furthermore, elimination of solvent from the production process may improve the mechanical integrity and/or stability of the electrode.

### Definitions

As used herein, “active material” refers to a material that can electrochemically react with lithium.

As used herein, “major surface” refers to a surface having a surface area equal to or greater than that of any other surface of an article.

As used herein, “negative electrode” refers to an electrode (often called an anode) where electrochemical oxidation and delithiation occurs during a discharging process.

As used herein, “positive electrode” refers to an electrode (often called a cathode) where electrochemical reduction and lithiation occurs during a discharging process.

As used in this specification and the appended embodiments, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used in this specification, the recitation of numerical ranges by endpoints includes all numbers and ranges subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In accordance with exemplary embodiments of the present disclosure, electrodes for use in lithium-ion electrochemical cells may be produced with solventless forms of materials, and without the addition of a separate solvent component. The electrodes of the present disclosure may exhibit useful properties at least equivalent to those of electrodes prepared using traditional solvent-based processes.

In some embodiments, electrodes for a lithium-ion electrochemical cell may include a current collector and an electroactive coating composition disposed on one or more major surfaces of the current collector.

In various embodiments, the current collector may include a metallic substrate that includes any conductive metal that is known by those of skill in the art to be useful in electronic applications. For example, current collectors useful in lithium-ion electrochemical cells may include thin foils of conductive metals or alloys such as, for example, aluminum, copper, tin, magnesium, stainless steel, nickel, titanium, and combinations or alloys thereof. The current collectors can have a thickness of from about 5 to about 20 microns, or any other desired thickness. The current collectors can be solid, or include holes or perforations (e.g., current collectors in the form of a grid or mesh). In some embodiments, a current collector for a positive electrode may include an aluminum substrate having two opposing major surfaces. In some embodiments, a current collector for a negative electrode may include a copper substrate having two opposing major surfaces.

Generally, the electrodes of the present disclosure may include current collectors having an electroactive coating composition thereon. In some embodiments, the electroactive coating compositions of the present disclosure may include any or all of active material, conductive diluent, and polymeric binder.

In various embodiments, the electrodes of the present disclosure may be positive electrodes. In such embodiments, suitable active materials for the electroactive coating compositions may include LiV₃O₈, LiV₂O₅, LiCo_{0.2}Ni_{0.8}O₂, LiNi_{0.33}Mn_{0.33}Co_{0.33}O₂, LiNi_{0.5}Mn_{0.3}Co_{0.2}O₂, LiNiO₂, LiFePO₄, LiMnPO₄, LiCoPO₄, LiMn₂O₄, LiCoO₂, and combinations thereof; mixed metal oxides of cobalt, manganese, and nickel such as those described in U.S. Pat. Nos. 6,964,828, 7,078,128 (both to Lu et al.), and 6,660,432 (Paulsen et al.); and nanocomposite materials such as those discussed in U.S. Pat. No. 6,680,145 (Obrovac et al.).

In illustrative embodiments, the electrodes of the present disclosure may include negative electrodes. In such embodiments, suitable active anode materials for the electroactive coating compositions may include alloys of silicon, tin, aluminum, gallium, indium, lead, bismuth, zinc, and combinations thereof. Useful active anode materials can also include alloys of tin or silicon such as Sn—Co—C alloys, Si₆₀Al₁₄Fe₈TiSn₇Mm₁₀ and Si₇₀Fe₁₀Ti₁₀C₁₀ where Mm is a Mischmetal (an alloy of rare earth elements). Useful active anode materials further include metal oxides such as Li₄Ti₅O₁₂, WO₃, and tin oxides. Other useful active anode materials include tin-based amorphous materials such as those disclosed in U.S. Pat. No. 7,771,876 (Mizutani et al.). Still further active anode materials may include graphitic carbons, e.g., those having a spacing between (002) crystallographic planes, d₀₀₂, of 3.45 Å>d₀₀₂>3.354 Å and existing in forms such as powders, flakes, fibers or spheres (e.g., mesocarbon microbeads), and combinations thereof.

In some embodiments, the electroactive coating compositions may include conductive diluent. The conductive diluent, for example, may include any form or type of elemental carbon. Exemplary carbons useful in electrodes include conductive carbons such as graphite, carbon black, lamp black, or other conductive carbon materials known to those of skill in the art. In various embodiments, exfoliatable carbon particles (i.e., those that break up into flakes, scales, sheets, or layers upon application of shear force) may be used. An example of useful exfoliatable carbon particles is HSAG300, available from Timcal Graphite and Carbon, Bodio, Switzerland. Other useful conductive diluents materials may include, but are not limited to SUPER P and ENSACO (Timcal).

In illustrative embodiments, the electroactive coating compositions may include a binder. The binder can function to improve adhesion of the components of the composition, as well as adhesion of the composition to the current collector. Any binders known to those of skill in the art of making electrodes for lithium batteries can be used. Exemplary polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Specific examples of polymer binders include polymers or copolymers of vinylidene fluoride, tetrafluoroethylene, and propylene; and copolymers of vinylidene fluoride and hexafluoropropylene. An exemplary binder that can be useful includes KYNAR 741 (polyvinylidene fluoride), available from Arkema, Oakville, Canada.

In some cases, the binders can be crosslinked. Crosslinking can improve the mechanical properties of the composition and can improve the contact between the active material and any electrically conductive diluent that can be present. Other binders include polyimides such as the aromatic, aliphatic or cycloaliphatic polyimides described in U. S. Pat. Publ. No. 2006/0099506 (Krause et al.).

Additional useful binders can include lithium polyacrylate as disclosed in co-owned application U. S. Pat. Publ. No. 2008/0187838 (Le). Lithium polyacrylate can be made from poly(acrylic acid) that is neutralized with lithium hydroxide. As used herein, poly(acrylic acid) includes any polymer or copolymer of acrylic acid or methacrylic acid or their derivatives where at least about 50 mole %, at least about 60 mole %, at least about 70 mole %, at least about 80 mole %, or at least about 90 mole % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, and the like.

In various embodiments, other optional components may also be included in the electroactive coating compositions of the present disclosure, as will be understood by those of ordinary skill. These optional ingredients may include materials such as pore formers, surfactants, flow agents, antioxidants, other conductive additives, and lithium salts.

In some embodiments, the proportion of the constituents in the electrode coating composition may be selected to form coatings of desired characteristics. The compositions may include up to 50 wt. %, up to 70 wt. %, up to 90 wt. %, 95 wt. %, up to 99 wt. %, or even up to 100 wt. % of active material based on the total weight of the coating composition. The compositions may include up to 1 wt. %, up to 2 wt. %, up to 5 wt. %, up to 10 wt. %, or even up to 20 wt. % of conductive diluent based on the total weight of the coating composition. The compositions may include up to 1 wt. %, up to 2 wt. %, up to 5 wt. %, up to 10 wt. %, or even up to 20 wt. % of binder based on the total weight of the coating composition. By varying the proportion of the constituents in the mixture, changes in the coating properties can be obtained.

In various embodiments, the components of the electrode coating compositions, individually, are substantially free of solvent, and no solvent is added during mixing of the components to form the coating composition. As used herein, “solvent” is given its generally accepted and understood meaning, and includes organic and inorganic liquids or plasticizers known to be used or useful to dissolve or soften other organic or inorganic materials, and specifically includes water. As with any industrial process, it may be impossible or impractical to remove 100% of residual solvents from the components of the composition. In this regard, for purpose of the present disclosure, “substantially free of solvent” refers to a component or composition that includes no greater than 2 wt. %, no greater than 1 wt. %, no greater than 0.5 wt. % solvent, or even no greater than 0.1 wt. % solvent based on the total weight of the component or composition.

In illustrative embodiments, electroactive coating compositions of the present disclosure may be coated onto one or more major surfaces of a current collector at an average thickness of less than about 200 micrometers, less than about 100 micrometers, less than about 50 micrometers, or even less than about 10 micrometers. Additionally, the electrode coating compositions may be coated onto one or more major surfaces of a current collector substantially uniformly. As used herein, “uniform” or “uniformly” means having a relatively consistent thickness of coating over the desired dimension of the plane of the current collector. The uniformity of the coating may be evaluated, for example, by optical evaluation using a spectrometer. To evaluate uniformity, a reflectance reading is taken at six points and compared to determine the variation. In some embodiments, the variation is no more than 10%, no more than 5%, or even no more than 3%.

In various embodiments, the electrodes of the present disclosure may include one or more additional coatings (in addition to the electroactive coating composition) disposed on one or more major surfaces of the current collectors. The one or more additional coatings may be disposed between the electroactive coating composition and the current collector, on top of the electroactive coating composition (i.e., the electroactive coating composition may be disposed between the current collector and the one or more additional coatings), or both. For example, in illustrative embodiments, a carbon coating, such as a nano-scale carbon coating described in U.S. Pat. App. Pub. 2010/0055569 (Divigalpitiya), which is herein incorporated by reference in its entirety, may be disposed between the current collector and the electroactive coating composition.

In some embodiments, a positive electrode and a negative electrode, such as those discussed above, can be combined with an electrolyte to form a lithium-ion electrochemical cell. Any suitable electrolyte can be included in the lithium ion electrochemical cell. The electrolyte can be in the form of a solid polymer or liquid or gel (combination of solid polymer plus liquid). Exemplary solid electrolytes include dry polymeric electrolytes such as polyethylene oxide, polytetrafluoroethylene, polyvinylidene fluoride, other fluorine-containing copolymers, polyacrylonitrile, or combinations thereof. Exemplary electrolyte gels include those described in U.S. Pat. Nos. 6,387,570 (Nakamura et al.) and 6,780,544 (Noh). Exemplary liquid electrolytes include ethylene carbonate, dimethyl carbonate, diethyl carbonate, propylene carbonate, gamma-butyrolactone, tetrahydrofuran, 1,2-dimethoxyethane, dioxolane, 4-fluoro-1,3-dioxalan-2-one, or combinations thereof. The electrolytes can also include ethyl methyl carbonate, vinylene carbonate, substituted vinylene carbonates, and halogenated cyclic carbonates such as, for example, 2-fluoroethyl carbonate. The electrolyte can include a charge-carrying lithium electrolyte salt such as LiPF₆, LiBF₄, LiClO₄, lithium bis(oxalato)borate, LiN(SO₂CF₃)₂, LiN(SO₂CF₂CF₃)₂, LiAsF₆, LiC(SO₂CF₃)₃, LiN(SO₂F)₂, LiN(SO₂F)(SO₂CF₃), LiN(SO₂F)(SO₂C₄F₉) and combinations thereof.

In some embodiments, the present disclosure may also relate to a method of making an electrode (e.g., the above-described electrodes). The method may include providing a metallic substrate (e.g., current collector). The metallic substrate can include any conductive metal that is known by those of skill in the art to be useful in electronic applications. Exemplary metals include aluminum, copper, magnesium, nickel, titanium, and tin.

The method may also include coating one or more major surfaces of the metallic substrate with a dry, substantially solvent free electroactive coating composition. The electroactive coating composition may be coated onto the metallic substrate directly (i.e., onto a bare metallic substrate) or indirectly (i.e., onto one or more coatings (e.g., carbon coatings) disposed on the metallic substrate).

The electroactive coating composition, as discussed above, may include any or all of active material, conductive diluent, and polymeric binder. The components of the electroactive coating composition may be combined together in their dry, solvent-free, or “neat” forms. That is, no solvent need be contained in any of the individual components and no additional solvent need be added to the individual or combined components. In some embodiments, the components of the electroactive coating composition may be combined together using a suitable mixing device (e.g., powder mixer). The components of the electroactive coating composition may be combined such that components are homogeneously blended.

In some embodiments, coating of the substrate may include buffing an effective amount of said dry, substantially solvent free electroactive coating composition on the metallic substrate. As used herein, “buffing” refers to any operation in which a pressure normal to a subject surface (e.g., a major surface of a metallic substrate) coupled with movement (e.g., rotational, lateral, combinations thereof) in a plane parallel to said subject surface is applied.

Buffing of the composition may be carried out using any buffing apparatus known in the art (e.g., power sander, power buffer, orbital sander, random orbital sander) suitable for applying dry particles to a surface, or manually (i.e., by hand). An exemplary buffing apparatus may include a motorized buffing applicator (e.g., disc, wheel) which may be configured to apply a pressure normal to a subject surface as well as rotate in a plane parallel to said subject surface. The buffing applicator may include a buffing surface that contacts with, or is intended to contact with, the subject surface during a buffing operation. In some embodiments, the buffing surface may include metal, polymer, glass, foam (e.g., closed-cell foam), cloth, paper, rubber, or combinations thereof. In various embodiments, the buffing surface may be formed of a material having a Brinell hardness of at least 0.1 HB, at least 1 HB, at least 10 HB, at least 100 HB, or even at least 1000 HB.

In some embodiments, the buffing surface may include or otherwise be associated with (e.g., be fitted with) a metal foil (e.g., aluminum foil). That is, the provided methods may include buffing electrode coating compositions onto a metallic substrate utilizing a metal foil as a buffing surface.

In some embodiments, the buffing applicator may be configured to move in a pattern parallel to the subject surface and to rotate about a rotational axis perpendicular to the subject surface. The pattern may include a simple orbital motion or random orbital motion. Rotation of the buffing applicator may be carried out as high as 100 orbits per minute, as high as 1,000 orbits per minute, or even as high as 10,000 orbits per minute. The buffing applicator may be applied in a direction normal to the subject surface at a pressure of a least 0.1 g/cm², at least 1 g/cm², at least 10 g/cm², at least 20 g/cm², or even at least 30 g/cm².

In illustrative embodiments, adherence of the electroactive coating composition to the metallic substrate may be assisted by heating the metallic substrate prior to, during, or after the buffing operation to a temperature such that the adhesion of the coating is enhanced. Exemplary methods of heat input to the metallic substrate may include oven heating, heat lamp heating (e.g., infrared), or a heated platen in contact with the metallic substrate. Direct application of electrical currents to conductive substrates may also produce the desired heating affect.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

### Materials

TABLE 1
Materials Used in the Preparation of the Examples

| Material | Description |
|---|---|
| Aluminum Foil | Grade 1145-H19, obtained from All-Foils, Inc., |
| | Strongsville, OH. |
| NMC | Li[Ni_{1/3}Mn_{1/3}Co_{1/3}]O₂ commercially available from 3M |
| Electroactive | Company, St. Paul, MN under trade designation “3M |
| Material | BATTERY CATHODE BC-618K”. |
| Conductive | Graphite, obtained from Timcal Ltd., Switzerland, |
| Diluent | under trade designation “SUPER C65”. |
| Binder-1 | Polyvinylidene fluoride, obtained from Sigma Aldrich |
| | Chemical Company, ON, Canada. |
| Binder-2 | Polyvinylidene fluoride, obtained from Arkema, Inc, |
| | King of Prussia, PA, under trade designation |
| | “KYNAR 761”. |
| Electrolyte-1 | 1M LiPF₆ in a mixture of ethylene carbonate, ethylmethyl |
| | carbonate, dimethyl carbonate, vinylene carbonate, |
| | 1,3-propane sultone, obtained from obtained from |
| | Novolyte Technologies, OH. |
| Electrolyte-2 | 1M LiPF₆ in a mixture of ethylene carbonate, diethyl |
| | carbonate (at 1:2 weight ratio), obtained from |
| | Novolyte Technologies, OH. |
| N-methyl-2- | Obtained from Aldrich Chemical Company, ON, Canada. |
| pyrrolidinone | |

### Method for SEM Analysis

Some electrode samples formed as described in these Examples were observed (both from above and cross-sections) under a scanning electron microscope (SEM; Hitachi TM-3000) and energy dispersive x-ray analysis (EDX; Bruker Quantax 70). The electrode samples were analyzed for the thickness, density (i.e., compactness), compositional uniformity and the physical integrity of the coatings. For the cross-sectional SEM and EDX analysis, the electrodes were cross sectioned normal to the plane of metal substrate (i.e., the metal foil) and the exposed cross sections were analyzed. At least one cross section was prepared for each sample. SEM and EDX analysis were carried out on at least one region of the samples and the results were reported qualitatively.

### Example 1

A sheet of Aluminum Foil was coated with an electroactive coating composition composed of a mixture of 96 wt % NMC Electroactive Material, 2 wt % Conductive Diluent, and 2% Binder-1. The electroactive composition was mixed using a SpeedMixer powder mixer (Model DAC 150 FVZ, obtained from FlacTek Inc, Landrum, S.C.) set at 3600 rpm for 20 seconds. The electroactive composition was buffed onto the Aluminum Foil using a buffing applicator (Power sander, Model B04900V, obtained from Makita Industrial Power Tools, La Mirada, Calif.) which was fitted with another sheet of Aluminum Foil as the buffing surface. After buffing, the resulting electrode was heated to 200° C. for 5 min to melt the binder. The NMC Electroactive Material loading was 3 mg/cm². It is expected that the thickness of the coating ranged from about 5-30 micrometers.

The prepared electrodes (positive electrode) of Example 1 were tested with lithium metal foil (negative electrode) in a standard 2325 coin-cell. The Li[Ni_{1/3}Mn_{1/3}Co_{1/3}]O₂/Li cells contained 40 L of Electrolyte-1. During testing, the operating voltage was 2.5-4.2 V and the cell temperature was maintained at 30° C.

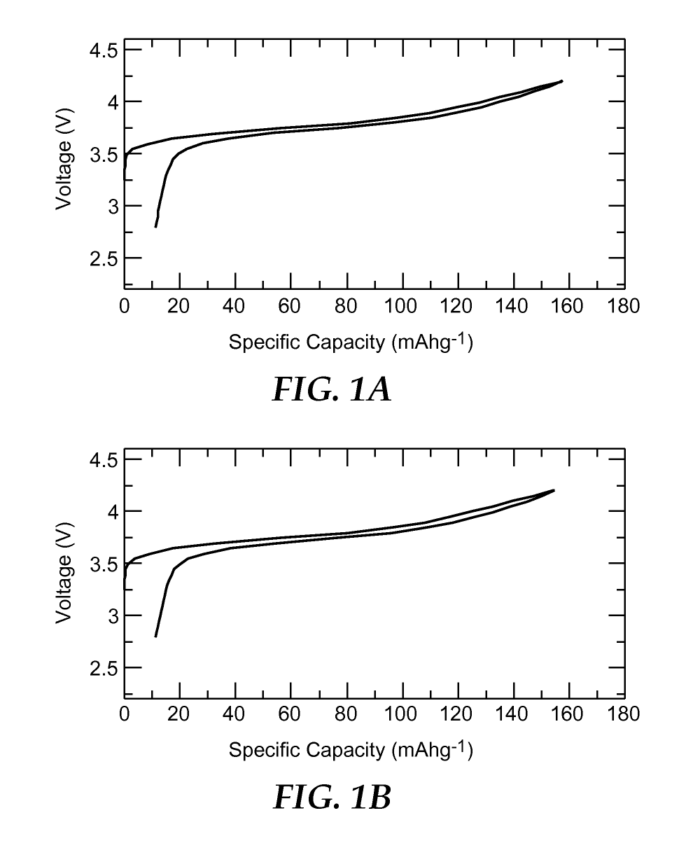

FIGS. 1A and 1B show the charge-discharge curves of the cells of this Example 1, cycled at C/20 rate. The behavior of the cells was consistent with the behavior of the Li[Ni_{1/3}Mn_{1/3}Co_{1/3}]O₂/Li cell of Comparative Example A.

### Example 2

An aluminum foil was coated with electrode powder composed of a mixture of 86 wt % NMC Electroactive Material, 7 wt % Conductive Diluent, and 7 wt % Binder-2. The electroactive composition was mixed using a SpeedMixer powder mixer set at 3600 rpm for 20 seconds. The electroactive composition was buffed onto the above aluminum foil by hand buffing using another sheet of Aluminum Foil as the buffing surface. After buffing, the resulting electrode was heated to 200° C. and pressed at a pressure of 6.89 MPa. After pressing and heating, the electrode had good adhesion, with no flaking of the positive electrode components. The NMC electroactive material loading was 13 mg/cm². It is expected that the thickness of the coating ranged from about 30-80 micrometers.

The prepared electrodes (positive electrode) of this Example 2 were tested with lithium metal foil (negative electrode) in a standard 2325 coin-cell. The Li[Ni_{1/3}Mn_{1/3}Co_{1/3}]O₂/Li cell contained 40 L of electrolyte-2. During testing, the operating voltage was 2.5-4.2 V and the cell temperature was maintained at 30° C.

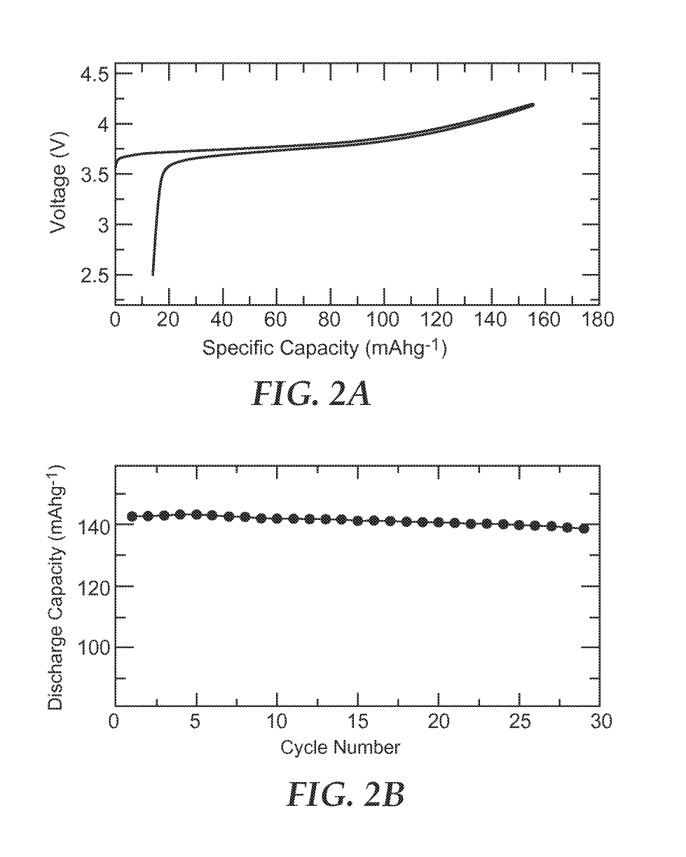

FIG. 2A shows the charge-discharge curve of the cell of this Example 2, cycled at C/20 rate. FIG. 2B shows the discharge capacity versus cycle number of the cell. The behavior of the cell was consistent with the behavior of the Li[Ni_{1/3}Mn_{1/3}Co_{1/3}]O₂/Li cell of Comparative Example A.

### Example 3

A 12.5-micrometer thick, electrochemical grade copper foil was coated with electroactive material composed of a silicon based alloy (as generally described in U.S. Pat. No. 8,071,238, which is incorporated by reference herein in its entirety) without any binders or conductive diluents present. The electroactive material was buffed onto the above copper foil by hand buffing using another sheet of copper foil as the buffing surface. The electrode had good adhesion, with no flaking of the positive electrode components. The electroactive material loading was 0.1 mg/cm².

The prepared electrode of this Example 3 was tested against lithium metal foil in a standard 2325 coin-cell. The cell contained 40 L of electrolyte-2. During testing, the operating voltage was 0-0.9 V and the cell temperature was maintained at 30° C.

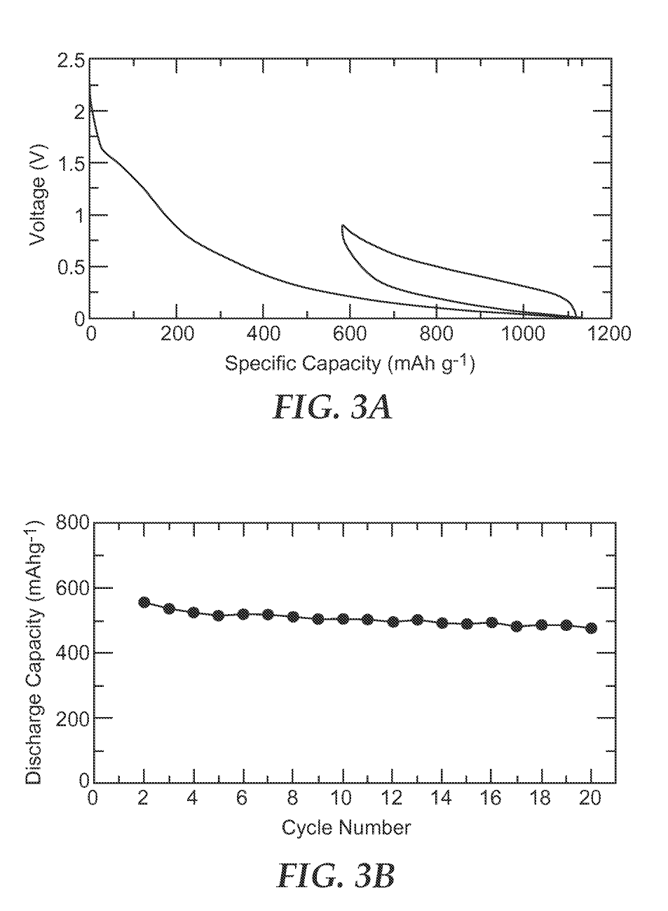

FIG. 3A shows the charge-discharge curve of the cell of this Example 3, cycled at C/20 rate. FIG. 3B shows the discharge capacity versus cycle number of the cell. The charge-discharge profile and cycling curves of the cell of this Example 3 were comparable to the expected behavior of cells having negative electrode materials of this type prepared using solvent-based methods.

### Comparative Example A

A sheet of Aluminum Foil was coated with electrode powder composed of a mixture of 86 wt % NMC Electroactive Material, 7 wt % Conductive Diluent, and 7% Binder-2. The electrode powder mixture was added to N-methyl-2-pyrrolidinone (at 40 weight % solids) using a Mazerustar plenary mixer (Model KK-505, obtained from Kurabo Industries, Ltd., Osaka, Japan). The resulting slurry was coated onto the above Aluminum Foil by casting using a notch-bar spreader with a cast height of 0.25 mm. After casting, the resulting electrode was heated to 120° C. for 2 hours to evaporate the N-methyl-2-pyrrolidinone, and then pressed at 6.89 MPa. The NMC Electroactive Material loading of the resulting electrode was 10 mg/cm². The coatings of Comparative Example A were compact, contained well dispersed NMC Electroactive Material in the coating, and were determined to contain all three components of the mixture. It is expected that the thickness of the coating ranged from about 20-60 micrometers. Qualitatively, the electrodes of Comparative Example A appeared similar to those of Examples 1-2, except that the electrodes of Examples 1-2 were slightly more compacted.

The prepared electrodes (positive electrode) of this Comparative Example A were tested with lithium metal foil (negative electrode) in a standard 2325 coin-cell. The Li[Ni_{1/3}Mn_{1/3}Co_{1/3}]O₂/Li cell contained 40 L of electrolyte-1. During testing, the operating voltage was 2.5-4.2 V and the cell temperature was maintained at 30° C.

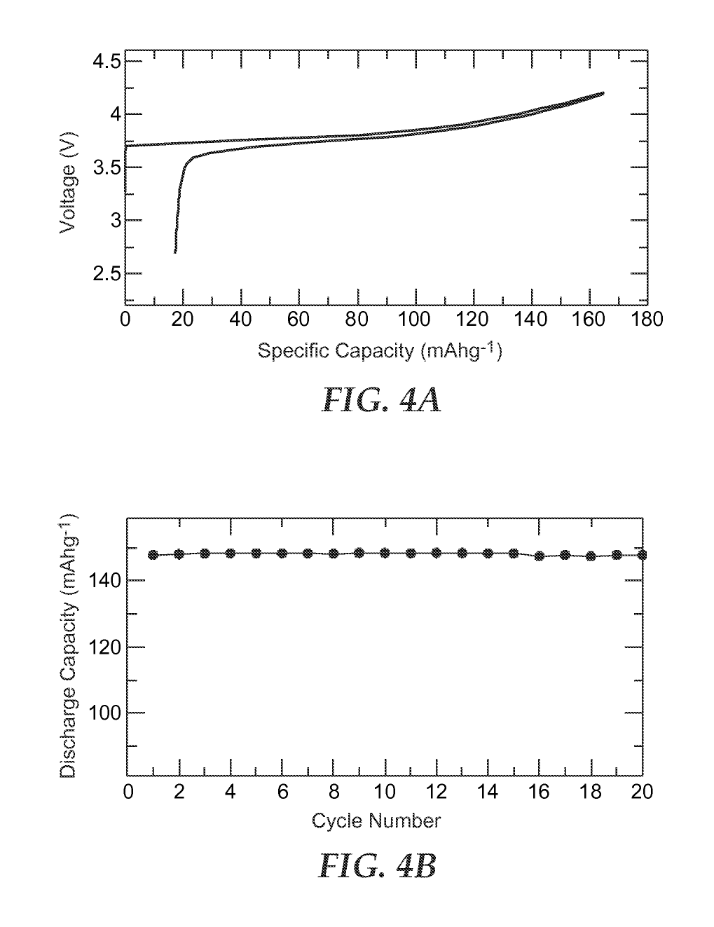

FIG. 4A shows the charge-discharge curve of the Li[Ni_{1/3}Mn_{1/3}Co_{1/3}]O₂/Li cell of this Comparative Example A, cycled at C/10 rate. FIG. 4B shows the discharge capacity versus cycle number of the cell. The cycling was stable at a discharge capacity of 148mAh g⁻¹.

Other embodiments of the invention are within the scope of the appended claims.

1. A method of forming an electrode for a lithium-ion battery, said method comprising:
providing a metallic substrate; and
coating the metallic substrate with a substantially solvent free electroactive coating composition;
wherein coating the metallic substrate comprises buffing the electroactive coating composition onto a major surface of the metallic substrate.

2. The method according to claim 1, wherein buffing the electroactive coating composition comprises buffing the electroactive coating composition using a buffing applicator comprising a buffing surface, and wherein the buffing surface comprises metal, paper, polymer, glass, foam, cloth, rubber, or combinations thereof.

3. The method according to claim 2, wherein the buffing surface comprises a metal foil.

4. The method according to claim 1, wherein the metallic substrate comprises aluminum, copper, magnesium, nickel, titanium, tin, or alloys thereof.

5. The method according to claim 1, wherein the electroactive coating composition comprises LiV₃O₈, LiV₂O₅, LiCo_{0.2}Ni_{0.8}O₂, LiNi_{0.33}Mn_{0.33}Co_{0.33}O₂, LiNi_{0.5}Mn_{0.3}Co_{0.2}O₂, LiNiO₂, LiFePO₄, LiMnPO₄, LiCoPO₄, LiMn₂O₄, LiCoO₂, or combinations thereof.

6. The method according to claim 1, wherein the electroactive coating composition comprises, Sn—Co—C alloys, Si₆₀Al₁₄Fe₈TiSn₇Mm₁₀, Si₇₀Fe₁₀Ti₁₀C₁₀, Li₄Ti₅O₁₂, WO₃, graphite, or combinations thereof.

7. The method according to claim 1, wherein the electroactive coating composition comprises a conductive diluent.

8. The method according to claim 7, wherein the conductive diluent comprises elemental carbon.

9. The method according to claim 1, wherein the electroactive coating composition comprises a binder.

10. The method according to claim 9, wherein the binder comprises polyvinylidene fluoride.

11. The method according to claim 1, wherein the electroactive coating composition comprises:
greater than about 50 weight percent active material;
from about 1 to about 20 weight percent conductive diluent; and
from about 1 to about 20 weight percent binder.

12. The method according to claim 1, wherein the electroactive coating composition comprises less than about 0.5 weight percent solvent.

13. An electrode for a lithium-ion battery, the electrode prepared by the method according to claim 1.

14. A lithium-ion battery comprising an electrode, the electrode prepared by the method according to claim 1.
